(19) United States
(12) Patent Application Publication
(10) Pub. No.: US 2011/0258988 A1
(43) Pub. Date: Oct. 27, 2011

(54) NOx SENSOR VALUE CORRECTING DEVICE AND INTERNAL COMBUSTION ENGINE EXHAUST PURIFICATION SYSTEM

(76) Inventor: Kenichi Tanioka, Saitama (JP)

(21) Appl. No.: 13/131,092

(22) PCT Filed: Aug. 31, 2009
(86) PCT No.: PCT/JP2009/065150

§ 371 Date: May 25, 2011

(30) Foreign Application Priority Data
Nov. 25, 2008 (JP) 2008-299670

(51) Int. Cl. F01N 3/10; G06F 19/00

(52) U.S. Cl. 60/276; 702/104

(57) ABSTRACT

To provide a NOₓ sensor value correcting device with improved precision in detecting NOₓ concentrations and an internal combustion engine exhaust purification system equipped with this sensor value correcting device.

A NOₓ sensor value correcting device that performs correction of a sensor value of a NOₓ sensor mounted on a downstream side of a catalyst used in reducing NOₓ estimates the ratio (RUno) of an upstream NO concentration and the ratio (RUno2) of an upstream NO₂ concentration with respect to an upstream NOₓ concentration on an upstream side of the catalyst and also estimates the efficiency (η) with which the NOₓ is purified in the catalyst, estimates the ratio (RLno) of a downstream NO concentration or the ratio (RLno2) of a downstream NO₂ concentration with respect to a downstream NOₓ concentration on the downstream side of the catalyst on the basis of the ratio (RUno) of the upstream NO concentration, the ratio (RUno2) of the upstream NO₂ concentration, and the efficiency (η) with which the NOₓ is purified in the catalyst, and corrects the sensor value (S) of the NOₓ sensor on the basis of the ratio (RLno) of the downstream NO concentration or the ratio (RLno2) of the downstream NO₂ concentration.

### TECHNICAL FIELD

The present invention relates to a NOₓ sensor value correcting device that performs correction of a sensor value of a NOₓ sensor disposed on a downstream side of a catalyst disposed in an exhaust passageway of an internal combustion engine and to an internal combustion engine exhaust purification system equipped this correcting means. The present invention particularly relates to a NOₓ sensor value correcting device that performs correction of a sensor value of a NOₓ sensor in consideration of differences in sensitivity with respect to NO and NO₂ and to an internal combustion engine exhaust purification system equipped this correcting device.

### BACKGROUND ART

Nitrogen oxides (NOₓ), which have the potential to affect the environment, are included in exhaust gas emitted from internal combustion engines such as diesel engines. As an exhaust purification system used to purify the NOₓ, there is known an exhaust purification system that injects and supplies a reducing agent, such as unburned fuel or an aqueous solution of urea, to an upstream side of a catalyst disposed in an exhaust passageway and uses the reducing agent to reduce the NOₓ in the exhaust gas in the catalyst.

In this exhaust purification system, the reducing agent flows out to the downstream side of the catalyst if the supply quantity of the reducing agent becomes excessive, and the NOₓ flows out to the downstream side of the catalyst if the supply quantity of the reducing agent becomes deficient. For that reason, feedback control of the reducing agent supply quantity, in which correction is performed such that a sensor value of a NOₓ sensor disposed on the downstream side of the catalyst becomes less than a predetermined threshold value, is performed with respect to the supply quantity of the reducing agent that has been obtained by computation in consideration of the operating state of the internal combustion engine and the reduction efficiency of the catalyst so as to not cause an excess or a deficiency in the supply quantity of the reducing agent.

There are also cases where the NOₓ sensor disposed on the downstream side of the catalyst is used in abnormality diagnosis for checking whether the exhaust purification system is working normally.

For example, there has been proposed an internal combustion engine exhaust purification system that has a reduction catalyst disposed in an exhaust passageway and uses a NOₓ sensor to more precisely estimate the degree of deterioration of the reduction catalyst. More specifically, the NOₓ sensor is disposed on the downstream side of the reduction catalyst, and the system calculates the difference between an estimated value of the NOₓ concentration in the exhaust gas in the exhaust passageway on the upstream side of the reduction catalyst and the sensor value of the NOₓ sensor at a time when the NOₓ in the exhaust gas is not being purified in the reduction catalyst. There has also been disclosed an internal combustion engine exhaust purification system which, when estimating the degree of deterioration of the reduction catalyst, corrects the estimated value of the NOₓ concentration in the exhaust gas in the exhaust passageway on the upstream side of the reduction catalyst on the basis of this difference and estimates the degree of deterioration of the reduction catalyst on the basis of the difference between this corrected value and the sensor value of the NOₓ sensor (see patent document 1).

### PRIOR ART DOCUMENTS

### Patent Documents

Patent Document 1: JP-A-2007-162603 (entire specification, all drawings)

### SUMMARY OF THE INVENTION

### Problem that the Invention is to Solve

However, there are many cases where the NOₓ sensor has different sensitivities with respect to NO and NO₂ as NOₓ. And there are cases where the sensor value of the NOₓ sensor gives rise to error with respect to the sensor value corresponding to the actual NOₓ concentration because NO and NO₂ are present in exhaust systems of internal combustion engines. As a result, there is the fear that the NOₓ sensor will not be able to accurately detect the actual NOₓ concentration in the exhaust system. When error arises between the NOₓ concentration obtained from the sensor value of the NOₓ sensor and the actual NOₓ concentration, there is the fear that the exhaust purification system will become unable to accurately perform the feedback control of the reducing agent injection quantity and will become unable to precisely perform the reduction and purification of the NOₓ in the exhaust gas, and there is also the fear that the reliability of abnormality diagnosis of the exhaust purification system will be lost.

Therefore, the inventor of the present invention earnestly endeavored to discover that this problem can be solved by estimating the ratios of the NO concentration and the NO₂ concentration on the downstream side of the catalyst and performing correction of the sensor value in consideration of the sensitivities of the NOₓ sensor with respect to NO and NO₂, and thus the inventor completed the present invention. That is, it is an object of the present invention to provide a NOₓ sensor value correcting device that corrects a sensor value of a NOₓ sensor having different sensitivities with respect to NO and NO₂ and improves the precision with which it detects NOₓ concentrations and an internal combustion engine exhaust purification system equipped with this sensor value correcting device.

### Means for Solving the Problem

According to the present invention, there is provided a NOₓ sensor value correcting device that performs correction of a sensor value of a NOₓ sensor mounted on a downstream side of a catalyst that is disposed in an exhaust passageway of an internal combustion engine and is used in reducing NOₓ included in exhaust gas emitted from the internal combustion engine, wherein the NOₓ sensor value correcting device estimates the ratio (RUno) of an upstream NO concentration and the ratio (RUno2) of an upstream NO₂ concentration with respect to an upstream NOₓ concentration on an upstream side of the catalyst and also estimates the efficiency (η) with which the NOₓ is purified in the catalyst, estimates the ratio (RLno) of a downstream NO concentration or the ratio (RLno2) of a downstream NO₂ concentration with respect to a downstream NOₓ concentration on the downstream side of the catalyst on the basis of the ratio (RUno) of the upstream NO concentration, the ratio (RUno2) of the upstream NO₂ concentration, and the efficiency (η) with which the NOₓ is purified in the catalyst, and corrects the sensor value (S) of the NOₓ sensor on the basis of the ratio (RLno) of the downstream NO concentration or the ratio (RLno2) of the downstream NO₂ concentration. Thus, the aforementioned problem can be solved.

Further, in configuring the NOₓ sensor value correcting device of the present invention, it is preferred that the NOₓ sensor value correcting device includes: an upstream NOₓ concentration computing unit that estimates the ratio (RUno) of the upstream NO concentration and the ratio (RUno2) of the upstream NO₂ concentration; a catalyst efficiency computing unit that estimates the efficiency (η) with which the NOₓ is purified in the catalyst; a downstream NOₓ concentration computing unit that estimates at least the ratio (RLno) of the downstream NO concentration or the ratio (RLno2) of the downstream NO₂ concentration with respect to the downstream NOₓ concentration on the downstream side of the catalyst; and a sensor value correcting unit that corrects the sensor value (S) of the NOₓ sensor on the basis of the ratio (RLno) of the downstream NO concentration or the ratio (RLno2) of the downstream NO₂ concentration.

Further, in configuring the NOₓ sensor value correcting device of the present invention, it is preferred that the downstream NOₓ concentration computing unit obtains the maximum ratio (η/2) in which the NO can be purified and the maximum ratio (η/2) in which the NO₂ can be purified with respect to the upstream NOₓ concentration on the upstream side of the catalyst on the basis of the efficiency (η) with which the NOₓ is purified in the catalyst and estimates the ratio (RLno) of the downstream NO concentration or the ratio (RLno2) of the downstream NO₂ concentration on the basis of the ratio (RUno) of the upstream NO concentration, the ratio (RUno2) of the upstream NO₂ concentration, the maximum ratio (η/2) in which the NO can be purified, and the maximum ratio (η/2) in which the NO₂ can be purified.

Further, in configuring the NOₓ sensor value correcting device of the present invention, it is preferred that the downstream NOₓ concentration computing unit subtracts the maximum ratio (η/2) in which the NO can be purified from the ratio (RUno) of the upstream NO concentration and also subtracts the maximum ratio (η/2) in which the NO₂ can be purified from the ratio (RUno2) of the upstream NO₂ concentration, in a case where both of the values (RLno′) and (RLno2′) obtained by subtraction are 0 or positive values, obtains the ratio (RLno) of the downstream NO concentration or the ratio (RLno2) of the downstream NO₂ concentration from the ratios of the values, in a case where the value (RLno′) obtained by subtracting the maximum ratio (η/2) in which the NO can be purified from the ratio (RUno) of the upstream NO concentration is a negative value, sets the ratio (RLno) of the downstream NO concentration to 0 and sets the ratio (RLno2) of the downstream NO₂ concentration to 1, and when the value (RLno2′) obtained by subtracting the maximum ratio (η/2) in which the NO₂ can be purified from the ratio (RUno2) of the upstream NO₂ concentration is a negative value, sets the ratio (RLno) of the downstream NO concentration to 1 and sets the ratio (RLno2) of the downstream NO₂ concentration to 0.

Further, another aspect of the present invention is an internal combustion engine exhaust purification system that is equipped with a reduction catalyst disposed in an exhaust passageway of an internal combustion engine and a NOₓ sensor disposed on a downstream side of the reduction catalyst and performs reduction of NOₓ included in exhaust gas emitted from the internal combustion engine, wherein the internal combustion engine exhaust purification system includes correcting means that estimates the ratio (RUno) of an upstream NO concentration and the ratio (RUno2) of an upstream NO₂ concentration with respect to an upstream NOₓ concentration on an upstream side of the catalyst and also estimates the efficiency (η) with which the NOₓ is purified in the catalyst, estimates the ratio (RLno) of a downstream NO concentration and the ratio (RLno2) of a downstream NO₂ concentration with respect to a downstream NOₓ concentration on the downstream side of the catalyst on the basis of the ratio (RUno) of the upstream NO concentration, the ratio (RUno2) of the upstream NO₂ concentration, and the efficiency (η) with which the NOₓ is purified in the catalyst, and corrects the sensor value (S) of the NOₓ sensor on the basis of the ratio (RLno) of the downstream NO concentration or the ratio (RLno2) of the downstream NO₂ concentration.

### Advantageous Effects of the Invention

According to the NOₓ sensor value correcting device of the present invention, the ratios of the NO and the NO₂ on the downstream side of the catalyst are precisely estimated and correction of the sensor value of the NOₓ sensor is performed on the basis of the estimation results, so even in a case where the sensitivities of the NOₓ sensor with respect to NO and NO₂ are different, the NOₓ concentration in the exhaust gas is precisely detected. As a result, feedback control of the reducing agent injection quantity and abnormality diagnosis of the exhaust purification system can be accurately performed.

Further, according to the internal combustion engine exhaust purification system of the present invention, even in a case where the sensitivities of the NOₓ sensor with respect to NO and NO₂ are different, the NOₓ concentration in the exhaust gas on the downstream side of the catalyst is precisely detected, and feedback control of the reducing agent and abnormality diagnosis of the exhaust purification system using the sensor value of the NOₓ sensor can be accurately performed.

### BRIEF DESCRIPTION OF THE DRAWINGS

FIG. 1 is a diagram showing an example configuration of an internal combustion engine exhaust purification system pertaining to an embodiment of the present invention;

FIG. 2 is a diagram for describing an example configuration of a NOₓ sensor used in the exhaust purification system of the embodiment of the present invention;

FIG. 3 is a block diagram showing an example configuration of a control device serving as a NOₓ sensor value correcting device pertaining to the embodiment of the present invention;

FIG. 4 is a flowchart for describing a method of controlling a reducing agent supply device including a step of correcting the sensor value of the NOₓ sensor; and

FIG. 5 is a flowchart for describing a way of obtaining the ratio of a downstream NO concentration and the ratio of a downstream NO₂ concentration with respect to a downstream NOₓ concentration.

### MODE FOR CARRYING OUT THE INVENTION

An embodiment relating to a NOₓ sensor value correcting device and an internal combustion engine exhaust purification system of the present invention will be specifically described below with reference to the drawings. However, the embodiment below represents one aspect of the present invention, is not intended to limit the present invention, and is capable of being arbitrarily changed within the scope of the present invention.

In the drawings, members to which the same reference signs have been given represent identical members, and description thereof will be appropriately omitted.

1. Internal Combustion Engine Exhaust Purification System

(1) Basic Configuration

First, the configuration of an internal combustion engine exhaust purification system (simply called an “exhaust purification system” below) pertaining to the embodiment of the present invention will be described.

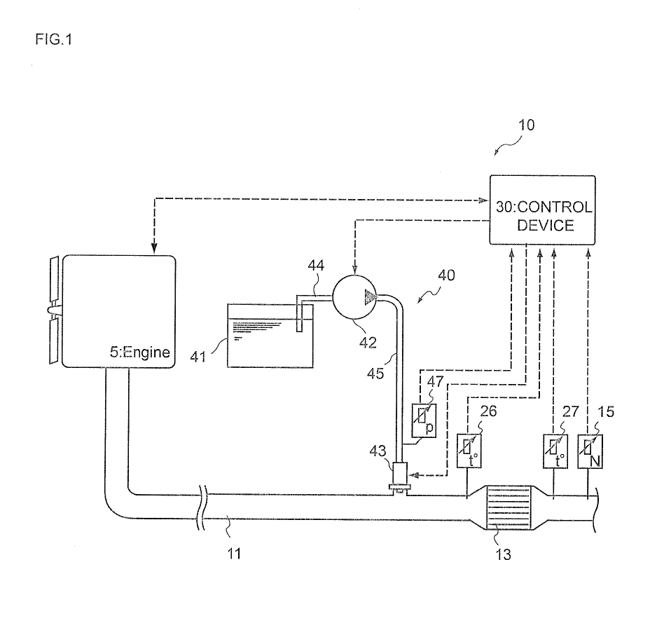

FIG. 1 shows the overall configuration of an exhaust purification system 10 that injects and supplies an aqueous solution of urea serving as a reducing agent to an upstream side of a reduction catalyst 13 disposed in an exhaust passageway 11 and selectively reduces and purifies NOₓ included in exhaust gas in the reduction catalyst 13. This exhaust purification system 10 is disposed in the middle of the exhaust passageway 11, which is connected to an internal combustion engine 5, and includes as its main elements the reduction catalyst 13 for selectively reducing the NOₓ included in the exhaust gas and a reducing agent supply device 40 for injecting and supplying the aqueous solution of urea to the inside of the exhaust passageway 11 on the upstream side of the reduction catalyst 13.

An upstream-side exhaust temperature sensor 26 is disposed on the upstream side of the reduction catalyst 13, and a downstream-side temperature sensor 27 and a NOₓ sensor 15 are disposed on a downstream side of the reduction catalyst 13. Instead of the downstream-side exhaust temperature sensor 27, temperature estimating means using the upstream-side exhaust temperature sensor 26 and the exhaust gas flow rate may also be disposed. Moreover, the exhaust purification system 10 is equipped with a control device 30 that performs action control of the reducing agent supply device 40 and functions as the NOₓ sensor value correcting device of the present embodiment.

The exhaust purification system 10 of the present embodiment is an exhaust purification system in which the aqueous solution of urea is used as a liquid reducing agent. The aqueous solution of urea is mixed together with the exhaust gas on the upstream side of the reduction catalyst 13, ammonia is generated by hydrolysis, and this ammonia adsorbed by the reduction catalyst 13. However, the reducing agent used in the exhaust purification system 10 of the present embodiment is not limited to the aqueous solution of urea; it suffices for the reducing agent to be one that can supply ammonia to the reduction catalyst 13.

(2) Reduction Catalyst

The reduction catalyst 13 which is used for the present exhaust purification system 10 adsorbs the ammonia generated as a result of the aqueous solution of urea injected into the exhaust gas by the reducing agent supply device 40 hydrolyzing and reduces the NOₓ in the inflowing exhaust gas. For this reduction catalyst 13, for example, a zeolite reduction catalyst that has an ammonia adsorbing function and is capable of selectively reducing the NOₓ is used.

(3) Reducing Agent Supply Device

The reducing agent supply device 40 is configured by a reducing agent injection valve 43 that is fixed to an exhaust passageway (an exhaust pipe) 11 on the upstream side of the reduction catalyst 13, a storage tank 41 in which the aqueous solution of urea serving as the liquid reducing agent is stored, and reducing agent pressure-feeding means 42 that pressure-feeds the aqueous solution of urea in the storage tank 41 to the reducing agent injection valve 43. A first supply passageway 44 is connected between the reducing agent between the reducing agent pressure-feeding means 42 and the storage tank 41, and a second supply path (second supply passageway) 45 is connected between the reducing agent pressure-feeding means 42 and the reducing agent injection valve 43. A reducing agent pressure sensor 47 used in drive control of the reducing agent pressure-feeding means 42 is disposed in the second supply path (second supply passageway) 45.

For the reducing agent injection valve 43 of the reducing agent supply device 40, for example, a reducing agent injection valve on which opening-and-closing control is performed by electric current control is used. The aqueous solution of urea pressure-fed from the reducing agent pressure-feeding means 42 to the reducing agent injection valve 43 is maintained at a predetermined pressure and is injected into the exhaust passageway when the reducing agent injection valve 43 has been opened by a control signal outputted from the control device 30.

A motor-driven pump is representatively used for the reducing agent pressure-feeding means 42, and the reducing agent pressure-feeding means 42 pumps up the aqueous solution of urea in the storage tank 41 and pressure-feeds it to the reducing agent injection valve 43. For this pump, for example, a motor-driven diaphragm pump or a gear pump is used, and drive control of the pump is performed by the control device 30.

The reducing agent supply device 40 may have the configuration described above where the aqueous solution of urea is injected from the reducing agent injection valve 43 directly into the exhaust passageway 11 or may have, for example, an air-assist configuration where high-pressure air is used to turn the aqueous solution of urea into a mist and the mist is supplied to the inside of the exhaust passageway 11.

(4) NOₓ Sensor

The NOₓ sensor 15 is disposed on the downstream side of the reduction catalyst 13 and is used to detect the NOₓ concentration in the exhaust gas.

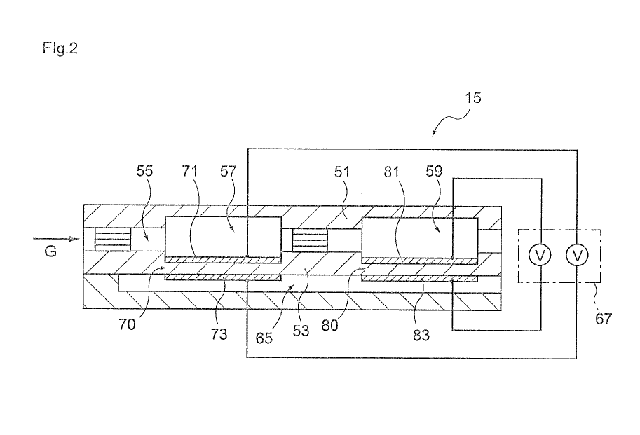

FIG. 2 is a cross-sectional diagram schematically showing one example of the configuration of the NOₓ sensor 15 used in the exhaust purification system 10 of the present embodiment. This NOₓ sensor 15 is equipped with an exhaust gas flow channel 55 formed by two solid electrolytes 51 and 53, and a first space 57 and a second space 59 are disposed in the middle of the exhaust gas flow channel 55.

A first element 70 is disposed facing the first space 57, and a second element 80 is disposed facing the second space 59. The first element 70 is configured as a result of a first inside electrode 71 and a first outside electrode 73 being placed on both sides of the solid electrolyte 53, with the first inside electrode 71 facing the first space 57 and the first outside electrode 73 facing a standard gas space 65. The second element 80 is configured as a result of a second inside electrode 81 and a second outside electrode 83 being placed on both sides of the solid electrolyte 53, with the second inside electrode 81 facing the second space 59 and the second outside electrode 83 facing the standard gas space 65.

In this NOₓ sensor 15, the first element 70 and the second element 80 are both utilized as oxygen pump elements. The first inside electrode 71 and the first outside electrode 73 configuring the first element 70 and the second inside electrode 81 and the second outside electrode 83 configuring the second element 80 are connected to an external connection circuit 67, and voltages are applied between the pairs of electrodes.

In the first element 70, voltage application is performed such that only oxygen is pumped out so as to ensure that NO of the NOₓ in the exhaust gas G does not dissociate. At this time, in the first space 57, as shown in equation (1) below, NO₂ dissociates into NO and oxygen.

2NO₂→2NO+O₂ (1)

Consequently, the oxygen that had originally been included in the exhaust gas G and the oxygen generated in the first space 57 are pumped out from the first space 57 by the first element 70.

In the second element 80, voltage application is performed so as to dissociate NO in the exhaust gas G and such that oxygen is pumped out. That is, in the second space, as shown in equation (2) below, NO dissociates into nitrogen and oxygen.

2NO→N₂+O₂ (2)

Consequently, the oxygen generated in the second space 59 is pumped out from the second space 59 by the second element 80.

At this time, the value of the current flowing in the second element 80 represents a current value corresponding to the concentration of oxygen pumped out from the second space 59, and this oxygen concentration represents the NOₓ concentration, so by measuring this current value, the NOₓ concentration in the exhaust gas is detected.

The NOₓ sensor 15 configured in this way dissociates the NO₂ of the NO and the NO₂ included in the exhaust gas, generates NO and oxygen, thereafter outputs as a sensor value S the current value corresponding to the concentration of oxygen generated by dissociating the NO, and detects the NO concentration on the basis of the sensor value S, so a difference arises between its sensitivity with respect to the NO and its sensitivity with respect to the NO₂. The sensitivities with respect to the NO and the NO₂ vary depending on the type of the NOₓ sensor, but in a case where, for example, an NOₓ sensor is designed such that its sensitivity with respect to the NO is 100%, sometimes its sensitivity with respect to the NO₂ becomes 80%.

2. Control Device (NOₓ Sensor Value Correcting Device)

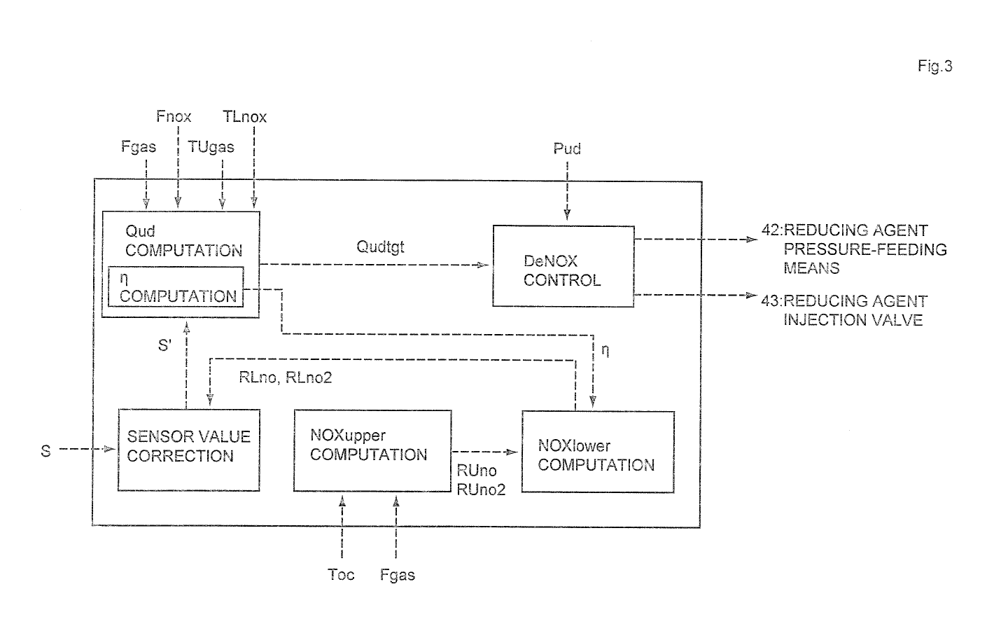

FIG. 3 shows an example configuration in which portions of the configuration of the control device 30 disposed in the exhaust purification system 10 of the present embodiment which perform control of the reducing agent supply device 40 and correction of the sensor value of the NOₓ sensor are represented by functional blocks.

This control device 30 includes as its main components a reducing agent injection quantity computing unit (“Qud Computation” in FIG. 3), a reducing agent supply device controlling unit (“DeNOX control” in FIG. 3), an upstream NOₓ concentration computing unit (“NOXupper Computation” in FIG. 3), a downstream NOₓ concentration computing unit (“NOXlower Computation” in FIG. 3), and a sensor value correcting unit (“Sensor Value Correction”) in FIG. 3). Each unit of the control device 30 is specifically realized by the execution of a program by a microcomputer (not shown).

(1) Reducing Agent Injection Quantity Computing Unit

The reducing agent injection quantity computing unit calculates the target injection quantity Qudtgt of the aqueous solution of urea on the basis of the flow rate Fgas of the exhaust gas and the flow rate Fnox of the NOₓ emitted from the internal combustion engine 5, the temperature Teat of the reduction catalyst 13 estimated from exhaust gas temperatures TUgas and TLgas on the upstream side and the downstream side of the reduction catalyst 13, the efficiency η (%) with which the NOₓ is reduced in the reduction catalyst 13, and the actual adsorption quantity Vact of the ammonia in the reduction catalyst 13.

Further, the reducing agent injection quantity computing unit of the control device 30 of the present embodiment performs correction of the target injection quantity Qudtgt on the basis of the sensor value S of the NOₓ sensor 15 disposed on the downstream side of the reduction catalyst 13 such that the NOₓ flowing out to the downstream side of the reduction catalyst 13 becomes less than a predetermined threshold value. The injection instruction value Qud calculated in this way is sent to the reducing agent supply device controlling unit. For the sensor value S used in the correction of the target injection quantity Qudtgt, specifically a corrected value S′ that has been corrected by the later-described sensor value correcting unit is used.

This reducing agent injection quantity computing unit is equipped with a catalyst efficiency computing unit (“η Computation” in FIG. 3) that estimates the efficiency η (%) with which the NOₓ is reduced in the reduction catalyst 13 (called “catalyst efficiency” below). In the catalyst efficiency computing unit of the control device 30 shown in FIG. 3, a map is stored beforehand such that the catalyst efficiency η (%) of the reduction catalyst 13 is selected in correspondence with the temperature Teat of the reduction catalyst 13 and the actual adsorption quantity of the ammonia (Vact). The catalyst efficiency η (%) is used in the computation of the target injection quantity Qudtgt of the reducing agent and is sent to the downstream NOₓ concentration computing unit. However, the method of estimating the catalyst efficiency η (%) is not limited to this method, and the catalyst efficiency η (%) can also be modeled in consideration of the temperature Teat of the reduction catalyst 13, the actual adsorption quantity Vact of the ammonia in the reduction catalyst 13, the flow rate Fgas of the exhaust gas, the NOₓ concentration NUnox on the upstream side of the reduction catalyst 13, the ratios of the upstream NO concentration NUno and the upstream NO₂ concentration NUno2, and the degree of deterioration of the reduction catalyst 13.

(2) Reducing Agent Supply Device Controlling Unit

The reducing agent supply device controlling unit uses the reducing agent pressure sensor 47 to perform feedback control of the reducing agent pressure-feeding means 42 on the basis of a pressure pud in the second supply path 45 and maintains the pressure in the second supply path 45 at a predetermined value. Further, the reducing agent supply device controlling unit performs opening-and-closing control of the reducing agent injection valve 43 on the basis of the injection instruction value Qud of the aqueous solution of urea that has been calculated by the reducing agent injection quantity computing unit.

(3) Upstream NOₓ Concentration Computing Unit

The upstream NO concentration computing unit estimates the ratio RUno (%) of the upstream NO concentration NUno and the ratio RUno2 (%) of the upstream NO₂ concentration NUno2 with respect to the upstream NO concentration NUnox on the upstream side of the reduction catalyst 13. Most of the NO emitted from the internal combustion engine 5 is NO, and usually an oxidation catalyst or a particulate filter having an oxidizing function is placed on the upstream side of the reduction catalyst 13 for the purpose of oxidizing the NO and improving the reduction efficiency by changing the ratios of the NO and the NO₂ flowing into the reduction catalyst 13. The ratios of the NO and the NO₂ after passing through the oxidation catalyst or the like are dependent on the temperature Toc of the oxidation catalyst or the like and the exhaust gas flow rate Fgas, so the upstream NOₓ concentration computing unit of the control device 30 of the present embodiment estimates the ratio RUno (%) of the upstream NO concentration NUno and the ratio RUno2 (%) of the upstream NO₂ concentration NUno2 on the upstream side of the reduction catalyst 13 on the basis of the temperature Toc of the oxidation catalyst or the like and the flow rate Fgas of the exhaust gas. However, the method of estimating the ratio RUno (%) of the upstream NO concentration NUno and the ratio RUno2 (%) of the upstream NO₂ concentration NUno2 is not limited to this example.

(4) Downstream NOₓ Concentration Computing Unit

The downstream NOₓ concentration computing unit estimates at least the ratio RLno (%) of the downstream NO concentration NLno or the ratio RLno2 (%) of the downstream NO₂ concentration NLno2 with respect to the downstream NOₓ concentration NLnox on the downstream side of the reduction catalyst 13. The downstream NOₓ concentration computing unit configuring the control device 30 of the exhaust purification system 10 of the present embodiment calculates the ratio RLno (%) of the downstream NO concentration NLno or the ratio RLno2 (%) of the downstream NO₂ concentration NLno2 in the following sequence.

First, the downstream NOₓ concentration computing unit subtracts the maximum ratio η/2 in which the NO can be purified from the ratio RUno (%) of the upstream NO concentration NUno and also subtracts the maximum ratio η/2 in which the NO₂ can be purified from the ratio RUno2 (%) of the upstream NO₂ concentration NUno2.

Here, the reason for subtracting the maximum ratios η/2 in which the NO and the NO₂ can be purified is because it is assumed that the reduction reaction in the reduction catalyst 13 progresses on the basis of the reaction equation of equation (3) below in which the reaction speed is fast and because the NO and the NO₂ are each purified in a maximum of η/2 when the reduction efficiency in the reduction catalyst 13 is η.

2NH₃+NO+NO₂→2N₂+3H₂O (3)

Next, in a case where both the value RLno′ (%) obtained by subtracting the maximum ratio η/2 in which the NO can be purified from the ratio RUno (%) of the upstream NO concentration NUno and the value RLno2′ (%) obtained by subtracting the maximum ratio η/2 in which the NO₂ can be purified from the ratio RUno2 (%) of the upstream NO₂ concentration NUno2 are 0 or positive values, the downstream NOₓ concentration computing unit obtains the ratio RLno (%) of the downstream NO concentration NLno or the ratio RLno2 (%) of the downstream NO₂ concentration NLno2 with respect to the downstream NOₓ concentration NLnox from the ratios of the values RLno′(%) and RLno2′(%).

In a case where the value RLno′ (%) obtained by subtracting the maximum ratio η/2 in which the NO can be purified from the ratio RUno (%) of the upstream NO concentration NUno is a negative value, the downstream NOₓ concentration computing unit sets the ratio RLno (%) of the downstream NO concentration NLno to 0 and sets the ratio RLno2 (%) of the downstream NO₂ concentration NLno2 to 100 (%). When the value RLno2′ (%) obtained by subtracting the maximum ratio η/2 in which the NO₂ can be purified from the ratio RUno2 (%) of the upstream NO₂ concentration NUno2 is a negative value, the downstream NOₓ concentration computing unit sets the ratio RLno (%) of the downstream NO concentration NLno to 100 (%) and sets the ratio RLno2 (%) of the downstream NO₂ concentration NLno2 to 0.

The ratios in the description above satisfy the following relationships.

RUno(%)+RUno2(%)=100%

RLno′(%)+RLno2′(%)≠100%

RLno(%)+RLno2(%)=100%

(5) Sensor Value Correcting Unit

The sensor value correcting unit corrects the sensor value S of the NOₓ sensor 15 on the basis of the ratio RLno (%) of the downstream NO concentration NLno or the ratio RLno2 (%) of the downstream NO₂ concentration NLno2. The sensor value correcting unit configuring the control device 30 of the present embodiment calculates the corrected value S′ of the sensor value on the basis of equation (4) below in a case where the sensitivity with respect to NO is X (%) and the sensitivity with respect to NO₂ is Y (%).

S′═S/{[1−(1−X/100)×RLno/100]−(1−Y/100)×RLno2/100} (4)

For example, in the case of a NOₓ sensor whose sensitivity with respect to NO is 95% and whose sensitivity with respect to NO₂ is 80%, equation (4) above is given by equation (5) below.

S′═S/{[1−(1−0.95)×RLno/100]−(1−0.8)×RLno2/100} (5)

Further, in the case of a NOₓ sensor designed such that its sensitivity with respect to NO is 100% and such that its sensitivity with respect to NO₂ is 80%, equation (4) above is given by equation (6) below.

S′═S/[1−(1−0.8)×RLno2/100] (6)

Table 1 shows an example of correction that has been performed using equation (6) above when, in the case of using a NOₓ sensor designed such that its sensitivity with respect to NO is 100% and such that its sensitivity with respect to NO₂ is 80%, the sensor value S of the NOₓ sensor has indicated that the NOₓ concentration (the downstream NOₓ concentration NLnox) is equal to 100 ppm.

TABLE 1

| | | | | | | | | Concentration |
|---|---|---|---|---|---|---|---|---|
| Concentration | | | | | | | | indicated by |
| indicated | | | | | | | | corrected |
| by sensor | RUno | RUno2 | η | RLno′ | RLno2′ | RLno | RLno2 | sensor value |
| value (ppm) | (%) | (%) | (%) | (%) | (%) | (%) | (%) | (ppm) |
| 100 | 40 | 60 | 60 | 10 | 30 | 25 | 75 | 117.64 |
| 100 | 20 | 80 | 60 | −10 | 50 | 0 | 100 | 125 |
| 100 | 80 | 20 | 60 | 50 | −10 | 100 | 0 | 100 |
| 100 | 50 | 50 | 80 | 10 | 10 | 50 | 50 | 111.11 |

As can be understood from Table 1, the sensor value correcting unit of the control device 30 of the present embodiment back-calculates the sensor value corresponding to NO or NO₂ of the sensor values S on the basis of the sensitivities of the NOₓ sensor 15 with respect to NO and NO₂, converts the sensor value to a state where the sensitivities of the NOₓ sensor with respect to NO and NO₂ are 100%, and calculates the corrected value S′. The corrected value S′ of the sensor value that has been calculated in this way is used in the correction of the target injection quantity Qudtgt of the reducing agent in the reducing agent injection quantity computing unit.

4. Method of Correcting Sensor Value of NOₓ Sensor (Method of Controlling Reducing Agent Supply Device)

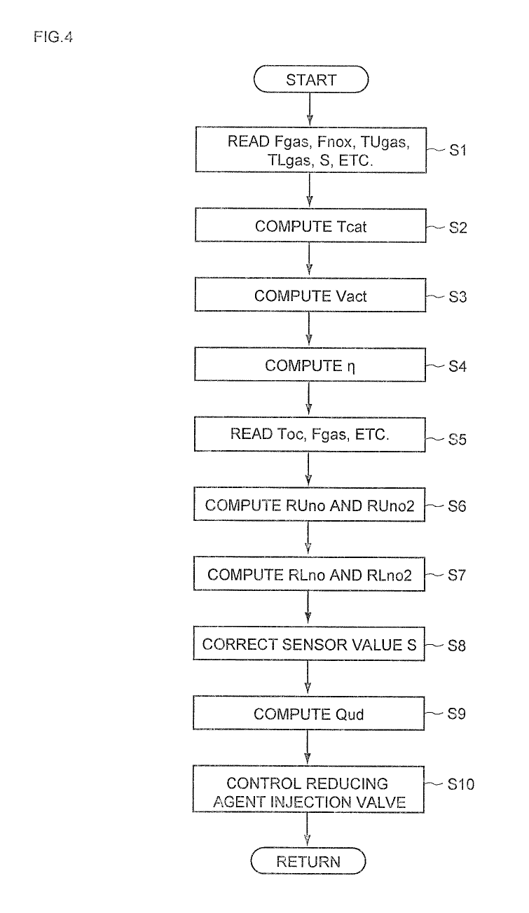

Next, a specific example of a method of controlling the reducing agent supply device including a step of correcting the sensor value of the NOₓ sensor which is performed by the control device 30 of the present embodiment that has been heretofore described will be described. FIG. 4 shows a flow of the method of controlling the reducing agent supply device of the present embodiment.

First, in step S1 after the start, the reducing agent injection quantity computing unit of the control device 30 reads the flow rate Fgas of the exhaust gas, the flow rate Fnox of the NOₓ, the exhaust gas temperatures TUgas and TLgas on the upstream side and the downstream side of the reduction catalyst 13, and the NOₓ sensor value S. Thereafter, in step S2 the reducing agent injection quantity computing unit estimates the temperature Teat of the reduction catalyst 13 by computation. Then, in step S3 the reducing agent injection quantity computing unit estimates the current actual adsorption quantity Vact of the ammonia in the reduction catalyst 13 by computation.

Next, in step S4 the reducing agent injection quantity computing unit of the control device 30 obtains the efficiency η with which the NOₓ is reduced in the reduction catalyst 13 from the temperature Tcat of the reduction catalyst 13 that was obtained in step S2 and the actual adsorption quantity Vact of the ammonia that was obtained in step S3.

Next, in step S5 the upstream NOₓ concentration computing unit of the control device 30 reads the temperature Toc of the oxidation catalyst or the particulate filter having an oxidizing function and the exhaust gas flow rate Fgas. In step S6 the upstream NOₓ concentration computing unit obtains the ratio RUno of the upstream NO concentration NUno and the ratio RUno2 of the upstream NO₂ concentration NUno2 with respect to the upstream NOₓ concentration NUnox on the basis of the values that were read in step S5.

Next, in step S7 the downstream NOₓ concentration computing unit of the control device 30 obtains the ratio RLno of the downstream NO concentration NLno and the ratio RLno2 of the downstream NO₂ concentration NLno2 with respect to the downstream NOₓ concentration NLnox on the basis of the ratio RUno of the upstream NO concentration NUno and the ratio RUno2 of the upstream NO₂ concentration NUno2 that were obtained in step S6 and the catalyst efficiency η of the reduction catalyst 13.

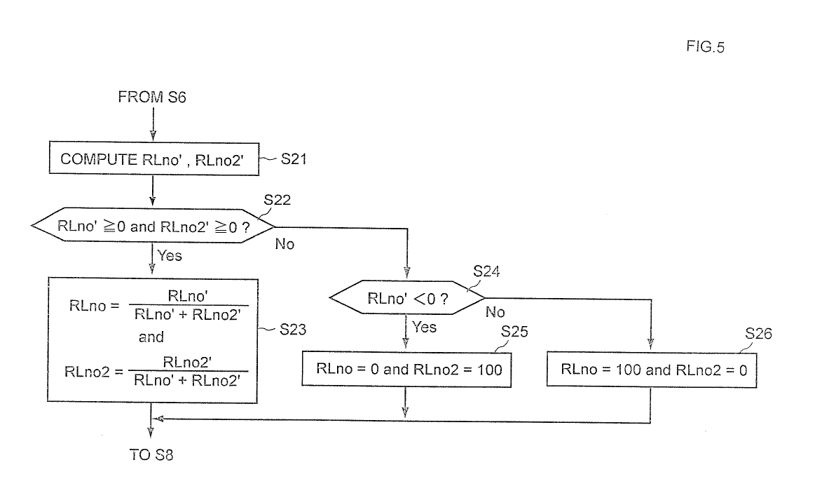

FIG. 5 is a flowchart showing a way of obtaining the ratio RLno of the downstream NO concentration NLno and the ratio RLno2 of the downstream NO₂ concentration NLno2 with respect to the downstream NOₓ concentration NLnox which is executed in step S7.

First, in step S21 the downstream NO concentration computing unit calculates the value RLno′ obtained by subtracting the maximum ratio η/2 in which the NO can be purified from the ratio RUno of the upstream NO concentration NUno and the value RLno2′ obtained by subtracting the maximum ratio η/2 in which the NO₂ can be purified from the ratio RUno2 of the upstream NO₂ concentration NUno2.

Next, in step S22 the downstream NOₓ concentration computing unit discriminates whether or not both of the values RLno′ and RLno2′ that were calculated in step S21 are equal to or greater than 0. In a case where both of the values are equal to or greater than 0, the downstream NOₓ concentration computing unit moves to step S23 where it obtains the ratio RLno of the downstream NO concentration NLno and the ratio RLno2 of the downstream NO₂ concentration NLno2 with respect to the downstream NOₓ concentration NLnox from the ratios of the values RLno′ and RLno2′.

In a case where both of the values RLno′ and RLno2′ are not equal to or greater than 0 in step S22, the downstream NOₓ concentration computing unit proceeds to step S24 where it discriminates whether or not the one value RLno′ is a negative value. In a case where the value RLno′ is a negative value, the downstream NOₓ concentration computing unit proceeds to step S25 where it sets the ratio RLno of the downstream NO concentration NLno to 0 and sets the ratio RLno2 of the downstream NO₂ concentration NLno2 to 100. In a case where the value RLno is positive, the other value RLno2 is a negative value, so the downstream NOₓ concentration computing unit sets the ratio RLno of the downstream NO concentration NLno to 100 and sets the ratio RLno2 of the downstream NO₂ concentration NLno2 to 0.

After the downstream NOₓ concentration computing unit has obtained the ratio RLno of the downstream NO concentration NLno and the ratio RLno2 of the downstream NO₂ concentration NLno2 with respect to the downstream NOₓ concentration NLnox in this way, in step S8 the sensor value correcting unit of the control device 30 performs correction of the sensor value S of the NOₓ sensor in accordance with equation (4) above on the basis of the ratio RLno of the downstream NO concentration NLno and the ratio RLno2 of the downstream NO₂ concentration NLno2 that were obtained in step S7.

Next, in step S9 the reducing agent injection quantity computing unit of the control device 30 obtains the target injection quantity Qudtgt of the reducing agent by computation on the basis of the flow rate Fgas of the exhaust gas, the flow rate Fnox of the NOₓ, and the actual adsorption quantity Vact of the ammonia and the catalyst efficiency η in the reduction catalyst 13 that were already inputted, references the corrected value S′ of the sensor value of the NOₓ sensor that was calculated in step S8, and performs correction of the target injection quantity Qudtgt such that the NOₓ concentration on the downstream side of the reduction catalyst 13 becomes less than a predetermined threshold value.

Then, in step S10 the reducing agent supply device controlling unit performs electric current control of the reducing agent injection valve 43 and supplies the reducing agent to the exhaust passageway in accordance with the injection instruction value Qud of the reducing agent after the correction that was calculated in step S9.

As described above, in the method of controlling the reducing agent supply device including the method of correcting the sensor value of the NOₓ sensor of the present embodiment, in performing the correction of the target injection quantity of the reducing agent such that the NOₓ concentration on the downstream side of the reduction catalyst 13 becomes less than a predetermined threshold value, there is used the corrected value S′ that is calculated by back-calculating the sensor value corresponding to NO or NO₂ of the sensor value S on the basis of the sensitivities of the NOₓ sensor 15 with respect to NO and NO₂ and converting the sensor value to a state where the sensitivities of the NOₓ sensor with respect to NO and NO₂ are 100%. Consequently, correction of the target injection quantity of the reducing agent is performed more accurately, and the quantity of the NOₓ that is released into the atmosphere can be decreased.

1-5. (canceled)

6. A NOₓ sensor value correcting device that performs correction of a sensor value of a NOₓ sensor mounted on a downstream side of a catalyst that is disposed in an exhaust passageway of an internal combustion engine and is used in reducing NOₓ included in exhaust gas emitted from the internal combustion engine,
wherein the NOₓ sensor value correcting device
estimates the ratio (RUno) of an upstream NO concentration and the ratio (RUno2) of an upstream NO₂ concentration with respect to an upstream NOₓ concentration on an upstream side of the catalyst and also estimates an efficiency (η) with which the NOₓ is purified in the catalyst,
estimates a ratio (RLno) of a downstream NO concentration or a ratio (RLno2) of a downstream NO₂ concentration with respect to a downstream NOₓ concentration on the downstream side of the catalyst based on the ratio (RUno) of the upstream NO concentration, the ratio (RUno2) of the upstream NO₂ concentration, and the efficiency (η) with which the NOₓ is purified in the catalyst, and
corrects the sensor value (S) of the NOₓ sensor based on the ratio (RLno) of the downstream NO concentration or the ratio (RLno2) of the downstream NO₂ concentration.

7. The NOₓ sensor value correcting device according to claim 6 comprising:
an upstream NOₓ concentration computing unit that estimates the ratio (RUno) of the upstream NO concentration and the ratio (RUno2) of the upstream NO₂ concentration;
a catalyst efficiency computing unit that estimates the efficiency (η) with which the NOₓ is purified in the catalyst;
a downstream NOₓ concentration computing unit that estimates at least the ratio (RLno) of the downstream NO concentration or the ratio (RLno2) of the downstream NO₂ concentration with respect to the downstream NOₓ concentration on the downstream side of the catalyst; and
a sensor value correcting unit that corrects the sensor value (S) of the NOₓ sensor based on the ratio (RLno) of the downstream NO concentration or the ratio (RLno2) of the downstream NO₂ concentration.

8. The NOₓ sensor value correcting device according to claim 7, wherein the downstream NOₓ concentration computing unit obtains a maximum ratio (η/2) in which the NO can be purified and the maximum ratio (η/2) in which the NO₂ can be purified with respect to the upstream NOₓ concentration on the upstream side of the catalyst based on the efficiency (η) with which the NOₓ is purified in the catalyst and estimates the ratio (RLno) of the downstream NO concentration or the ratio (RLno2) of the downstream NO₂ concentration based on the ratio (RUno) of the upstream NO concentration, the ratio (RUno2) of the upstream NO₂ concentration, the maximum ratio (η/2) in which the NO can be purified, and the maximum ratio (η/2) in which the NO₂ can be purified.

9. The NOₓ sensor value correcting device according to claim 8, wherein the downstream NOₓ concentration computing unit
subtracts the maximum ratio (η/2) in which the NO can be purified from the ratio (RUno) of the upstream NO concentration and also subtracts the maximum ratio (η/2) in which the NO₂ can be purified from the ratio (RUno2) of the upstream NO₂ concentration,
in a case where both values (RLno′) and (RLno2′) obtained by subtraction are zero or positive values, obtains the ratio (RLno) of the downstream NO concentration or the ratio (RLno2) of the downstream NO₂ concentration from ratios of the values,
in a case where the value (RLno′) obtained by subtracting the maximum ratio (η/2) in which the NO can be purified from the ratio (RUno) of the upstream NO concentration is a negative value, sets the ratio (RLno) of the downstream NO concentration to 0 and sets the ratio (RLno2) of the downstream NO₂ concentration to 1, and
when the value (RLno2′) obtained by subtracting the maximum ratio (η/2) in which the NO₂ can be purified from the ratio (RUno2) of the upstream NO₂ concentration is a negative value, sets the ratio (RLno) of the downstream NO concentration to 1 and sets the ratio (RLno2) of the downstream NO₂ concentration to 0.

10. An internal combustion engine exhaust purification system that is equipped with a reduction catalyst disposed in an exhaust passageway of an internal combustion engine and a NOₓ sensor disposed on a downstream side of the reduction catalyst and performs reduction of NOₓ included in exhaust gas emitted from the internal combustion engine,
wherein the internal combustion engine exhaust purification system includes correcting means that estimates a ratio (RUno) of an upstream NO concentration and a ratio (RUno2) of an upstream NO₂ concentration with respect to an upstream NOₓ concentration on an upstream side of the catalyst and also estimates an efficiency (η) with which the NOₓ is purified in the catalyst, estimates a ratio (RLno) of a downstream NO concentration and a ratio (RLno2) of a downstream NO₂ concentration with respect to a downstream NOₓ concentration on the downstream side of the catalyst based on the ratio (RUno) of the upstream NO concentration, the ratio (RUno2) of the upstream NO₂ concentration, and the efficiency (η) with which the NO is purified in the catalyst, and corrects the sensor value (S) of the NOₓ sensor based on the ratio (RLno) of the downstream NO concentration or the ratio (RLno2) of the downstream NO₂ concentration.
